(19) United States
(12) Patent Application Publication
(10) Pub. No.: US 2020/0162004 A1
(43) Pub. Date: May 21, 2020

(54) INDUCTION MOTOR CONTROL

(71) Applicant: Edwards Limited, Burgess Hill, Sussex (GB)

(72) Inventors: Jian Li, Burgess Hill, Sussex (GB); James Alexander Haylock, Burgess Hill, Sussex (GB)

(21) Appl. No.: 16/634,423

(22) PCT Filed: Jul. 23, 2018
(86) PCT No.: PCT/GB2018/052070

§ 371 Date: Jan. 27, 2020

(30) Foreign Application Priority Data
Jul. 28, 2017 (GB) 1712161.7

(51) Int. Cl. H02P 21/36; H02P 21/00; H02P 21/22; H02P 27/12

(52) U.S. Cl. CPC H02P 21/36; H02P 21/0089; H02P 2201/03; H02P 27/12; H02P 21/22

(57) ABSTRACT

A method of controlling an induction motor, an apparatus and a computer program product are disclosed. The method comprises: in response to an indication that a rotational frequency of the rotor is to be reduced from an initial operating frequency to a reduced operating frequency, applying an alternating braking voltage to the stator, the alternating braking voltage having a frequency selected to provide a slip of less than around −1. In this way, the applied to alternating braking voltage generates a negative torque to slow the rotor while ensuring that a large proportion of the power generated by the motor is dissipated within the motor itself. This helps to reduce the amount of power required to be dissipated by any driving circuitry.

### CROSS-REFERENCE OF RELATED APPLICATION

This application is a Section 371 National Stage Application of International Application No. PCT/GB2018/052070, filed Jul. 23, 2018, and published as WO 2019/020980 A1 on Jan. 31, 2019, the content of which is hereby incorporated by reference in its entirety and which claims priority of British Application No. 1712161.7, filed Jul. 28, 2017.

### FIELD

The present invention relates to a method of controlling an induction motor, an apparatus and a computer program product.

### BACKGROUND

Induction motors are known and are an electric motor in which the electric current in the rotor needed to produce torque is obtained by electromagnetic induction from the magnetic field of the stator winding. Although the use of induction motors can provide many benefits, their use can also lead to unexpected consequences. Accordingly, it is desired to provide an improved technique for controlling induction motors.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided a method of controlling an induction motor having a rotor and stator, comprising: in response to an indication that a rotational frequency of the rotor is to be reduced from an initial operating frequency to a reduced operating frequency, applying an alternating braking voltage to the stator, the alternating braking voltage having a frequency selected to provide a slip of less than around −1.

The first aspect recognises that a problem with induction motors is that they can be difficult to slow, particularly when driving loads with high inertia. Although various techniques exist to slow induction motors, they each have their own shortcomings which includes high-complexity, requiring additional components for power dissipation, causing high degrees of shock to the motor, risking restarting the motor in a reverse direction, etc. Accordingly, a method is provided. The method may control an induction motor. The induction motor may have a rotor and a stator. The method may comprise that in response to, or upon receipt of, an indication or signal that a rotational frequency or speed of the rotor is to be reduced or changed from an initial or current operating frequency or speed to a reduced or lower operating frequency or speed, applying an alternating braking voltage to the stator. The alternating braking voltage may have a frequency which is selected or set to cause regenerated power to be dissipated within the induction motor. The alternating braking voltage may have a frequency which is selected or set to provide a slip which is less than, or more negative than, around −1. In this way, the applied alternating braking voltage generates a negative torque to slow the rotor while ensuring that a large proportion of the power regenerated by the rotor inertia is dissipated within the motor itself. This helps to reduce the amount of power required to be dissipated by any driving circuitry.

In one embodiment, the alternating braking voltage has a frequency selected to provide a slip of less than around −3, and preferably between around −3 and −30. By setting the frequency of the braking voltage to provide a highly negative slip, the proportion of the regenerated power dissipated by the motor is increased.

In one embodiment, the alternating braking voltage has a frequency which is less than half of the reduced operating frequency.

In one embodiment, the alternating braking voltage has a frequency which is greater than 0 Hertz. Accordingly, the alternating braking voltage is other than a DC braking voltage.

In one embodiment, the alternating braking voltage has a frequency which is greater than around 1% of the reduced operating frequency.

In one embodiment, the alternating braking voltage has a frequency which is around 3% of the reduced operating frequency. This helps to ensure the generation of a high amount of negative slip.

In one embodiment, the method comprises varying a frequency of the alternating braking voltage in proportion to the current operating frequency of the rotor. Accordingly, the frequency of the alternating braking voltage may be adjusted, dependent upon the instantaneous speed of the rotor, in order to continue to apply the required slip.

In one embodiment, the method comprises varying the frequency of the alternating braking voltage in proportion to the current operating frequency of the rotor to obtain a desired power dissipation inside the induction motor and to avoid power feedback to a drive DC link. Accordingly, the frequency of the alternating braking voltage may be adjusted as the speed of the motor changes in order to adjust the power dissipated by the induction motor.

In one embodiment, the method comprises varying the frequency of the alternating braking voltage in proportion to the current operating frequency of the rotor to obtain a desired slip to achieve the desired power dissipation inside the induction motor and preferably by at least one of the rotor and the stator to avoid power dissipation in a drive DC link. Accordingly, the frequency of the alternating braking voltage may be adjusted to adjust the slip to provide the required power dissipation within the induction motor.

In one embodiment, the method comprises varying the frequency of the alternating braking voltage to obtain a desired current generated by the induction motor.

In one embodiment, the method comprises increasing the frequency of the alternating braking voltage when a current generated by the induction motor is greater than the desired current. Accordingly, the frequency of the alternating braking voltage may be increased in order to reduce the amount of current being generated within the induction motor.

In one embodiment, the method comprises decreasing the frequency of the alternating braking voltage when a current generated by the induction motor is less than the desired current. Accordingly, the frequency of the alternating braking voltage may be reduced in order to increase the current generated by the induction motor.

In one embodiment, in response to the indication that the rotational frequency of the rotor is to be reduced from the initial operating frequency to the reduced operating frequency, the method comprises continuing to drive the induction motor with reduced flux in combination with applying the alternating braking voltage by reducing a magnitude of an alternating drive voltage. By continuing to drive the induction motor concurrently with applying the alternating braking voltage, the induction motor drive circuitry can remain in synchronisation with the reducing speed of the induction motor. Reducing the magnitude of the alternating drive voltage reduces the flux of the motor and so reduces the torque experienced by the rotor in response to the alternating drive voltage when applying the alternating braking voltage. This helps to prevent the alternating drive voltage from working against the alternating braking voltage.

In one embodiment, the magnitude of the alternating drive voltage is reduced by around more than half.

In one embodiment, a magnitude of the alternating braking voltage is higher than the magnitude of the alternating drive voltage.

In one embodiment, the method comprises varying the magnitude of the alternating braking voltage based on a current operating frequency of the rotor. Accordingly, the amplitude of the alternating braking voltage may be adjusted based on the instantaneous speed of the motor.

In one embodiment, the method comprises varying the magnitude of the alternating braking voltage to obtain a desired current generated by the induction motor.

In one embodiment, the method comprises reducing the magnitude of the alternating braking voltage when a current generated by the induction motor is greater than the desired current.

In one embodiment, the method comprises increasing the magnitude of the alternating braking voltage when a current generated by the induction motor is less than the desired current.

In one embodiment, the method comprises ceasing to apply the alternative braking voltage when the rotational frequency of the rotor achieves the reduced operating frequency. Accordingly, when the reduced speed has been achieved then the alternating braking voltage may be removed.

In one embodiment, the method comprises increasing the magnitude of the alternating drive voltage. Accordingly, the induction motor can then be continued to be driven at the reduced operating frequency.

According to a second aspect, there is provided an apparatus comprising: control logic operable, in response to an indication that a rotational frequency of a rotor of an induction motor is to be reduced from an initial operating frequency to a reduced operating frequency, to apply an alternating braking voltage to the stator, the alternating braking voltage having a frequency selected to provide a slip of less than around −1.

In one embodiment, the alternating braking voltage has a frequency selected to provide a slip of less than around −3, and preferably between around −3 and −30.

In one embodiment, the alternating braking voltage has a frequency which is less than half of the reduced operating frequency.

In one embodiment, the alternating braking voltage has a frequency which is greater than 0 Hertz.

In one embodiment, the alternating braking voltage has a frequency which is greater than around 1% of the reduced operating frequency.

In one embodiment, the alternating braking voltage has a frequency which is around 3% of the reduced operating frequency.

In one embodiment, the control logic is operable to vary a frequency of the alternating braking voltage in proportion to the current operating frequency of the rotor.

In one embodiment, the control logic is operable to vary the frequency of the alternating braking voltage in proportion to the current operating frequency of the rotor to obtain a desired power dissipation inside the induction motor and preferably by at least one of the rotor and the stator to avoid power dissipation in a drive DC link.

In one embodiment, the control logic is operable to vary the frequency of the alternating braking voltage in proportion to the current operating frequency of the rotor to obtain a desired slip to achieve the desired power dissipation inside the induction motor and preferably by at least one of the rotor and the stator to avoid power dissipation in a drive DC link.

In one embodiment, the control logic is operable to vary the frequency of the alternating braking voltage to obtain a desired current generated by the induction motor.

In one embodiment, the control logic is operable to increase the frequency of the alternating braking voltage when a current generated by the induction motor is greater than the desired current.

In one embodiment, the control logic is operable to decrease the frequency of the alternating braking voltage when a current generated by the induction motor is less than the desired current.

In one embodiment, the control logic is operable, in response to the indication that the rotational frequency of the rotor is to be reduced from the initial operating frequency to the reduced operating frequency, to continue to drive the induction motor with reduced flux in combination with applying the alternating braking voltage by reducing a magnitude of an alternating drive voltage.

In one embodiment, the control logic is operable to reduce the magnitude of the alternating drive voltage by around more than half.

In one embodiment, a magnitude of the alternating braking voltage is higher than the magnitude of the alternating drive voltage.

In one embodiment, the control logic is operable to vary the magnitude of the alternating braking voltage based on a current operating frequency of the rotor.

In one embodiment, the control logic is operable to vary the magnitude of the alternating braking voltage to obtain a desired current generated by the induction motor.

In one embodiment, the control logic is operable to reduce the magnitude of the alternating braking voltage when a current generated by the induction motor is greater than the desired current.

In one embodiment, the control logic is operable to increase the magnitude of the alternating braking voltage when a current generated by the induction motor is less than the desired current.

In one embodiment, the control logic is operable to cease applying the alternative braking voltage when the rotational frequency of the rotor achieves the reduced operating frequency.

In one embodiment, the control logic is operable to increase the magnitude of the alternating drive voltage.

In one embodiment, the apparatus comprises the induction motor.

According to a third aspect, there is provided a computer program product operable, when executed on a computer, to perform the method of the first aspect.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates a controller according to one embodiment:

FIG. 2 is a graph showing the relationship between slip and torque in an induction motor;

FIG. 3(A) provides graphs of voltages as a function of time during slowing of the induction motor.

FIG. 3(B) provide loci of voltage and frequency.

FIG. 3(C) shows graphs of current, voltage and power as motor frequency decreases.

FIG. 4 shows the phase A motoring and braking voltage and the actual sum of the two voltages, according to one embodiment;

FIG. 5 shows the three phase voltages during the braking operation, according to one embodiment;

FIG. 6 shows a deceleration current and DC link voltage waveforms in existing control circuitry without applying techniques of embodiments; and

FIG. 7 shows the deceleration and DC link voltage waveforms according to one embodiment.

### DETAILED DESCRIPTION

Before discussing the embodiments in any more detail, first an overview will be provided. Embodiments provide a technique for controlling an induction motor. In particular, embodiments relate to performing braking (i.e., reducing the rotational speed) of an induction motor. A controller is provided which typically maintains an alternating drive (motoring) voltage which was being provided to the motor prior to the reduction in speed being required, while concurrently applying an alternating braking voltage to slow the motor. Typically, the magnitude of the alternating drive voltage is reduced, in order to reduce the flux of the motor and so reduce the driving torque. Continuing to apply the alternating drive voltage helps to ensure that the speed of the motor can be tracked, so that the frequency of the alternating drive voltage continues to match that of the motor (i.e. the circuitry generating the alternating drive voltage remains synchronised with the motor), and so the alternating drive voltage can be reapplied, if required, once the reduced operating speed has been achieved. This helps to ensure that no power spikes or rotational stresses occur when reapplying the alternating drive voltage.

As mentioned above, in order to slow or apply a braking torque to the motor, an alternating braking voltage is applied to the motor. The alternating braking voltage is typically applied concurrently, simultaneously or in superposition with the alternating drive voltage. The frequency of the alternating braking voltage is selected to generate a negative slip. It will be appreciated that the concept of induction motor slip is well understood in the field of induction motors. In particular, the slip may be defined as the difference between the speed of the magnetic field and the rotating speed of the rotor and, in particular, slip=(Fstator−Frotor)/Fstator. Adjusting the stator frequency to generate a negative slip causes power generation within the induction motor. Although the peak braking torque occurs for a slip of between 0 and −1, the bulk of the power generated by the motor at that slip is transferred into the power electronic drive, which would need to be dissipated in order to prevent damage to the power electronic drive. However, when the slip is more negative than −1, more power is dissipated within the motor itself than by the power electronic drive and the ratio of power dissipated within the motor increases as the slip becomes more negative. By varying the frequency (and typically the magnitude) of the alternating braking voltage, the speed of the motor can be reduced to slow the motor more quickly than without the alternating braking voltage while controlling the amount of power being transferred to the motor drive circuitry.

### Controller

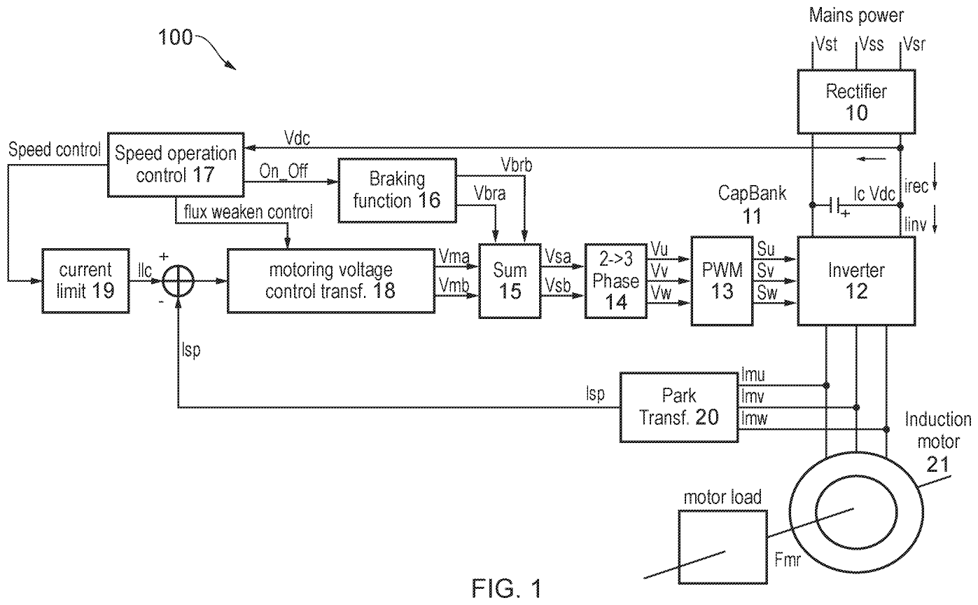

FIG. 1 illustrates a controller, generally 100, according to one embodiment. The controller 100 comprises an inverter power and control system. Under a normal motoring operation, a three phase alternating current (AC) power supply voltage Vst, Vss, Vsr is converted into direct current (DC) voltage Vdc by a diode rectifier 10. A capacitor bank 11 stores and smooths the DC voltage Vdc, then inverter 12 converts the DC voltage Vdc into a three phase voltage supply to induction motor 21 to drive the motor load.

The motor speed is controlled by speed operation control 17, which provides the normal motoring voltage and frequency to the motoring voltage control and transformation block 18, which transforms into two phase motoring voltages Vma and Vmb in a stationary reference frame. During normal motoring operation, the brake voltages Vbra and Vbrb are zeros. Accordingly, the summing logic 15 outputs two summed voltages Vsa and Vsb which are equal to the motoring voltages Vma and Vmb. The summed voltages Vsa and Vsb are converted into three phase summed voltages, Vu, Vv and Vw by a 2-to-3 phase converter 14, then they are pulse width modulated (PWM) to generate PWM signals Su, Sv, Sw by a pulse width modulator 13 and provide to gate an inverter 12 and which outputs the desired voltage and frequency to the motor 21.

### Slip Characteristics

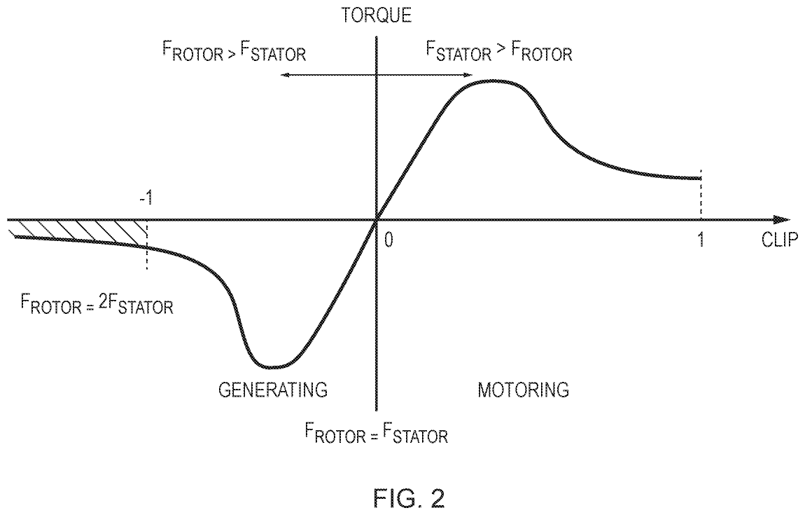

FIG. 2 is a graph showing the relationship between slip and torque in an induction motor. As can be seen, at 0 slip, no torque is experienced. A positive slip causes the motor to drive, while a negative slip causes the motor to generate. As the slip becomes negative, power is generated by the motor and is initially transferred to the controller 100. When the slip reaches −1 (meaning that the frequency of the applied voltage is half that of the current rotational speed of the rotor), then around half of the power generated by the motor is dissipated within the motor. As the slip becomes more negative, the proportion of power dissipated by the motor increases and the amount of power transferred to the controller 100 reduces.

### Braking Operation

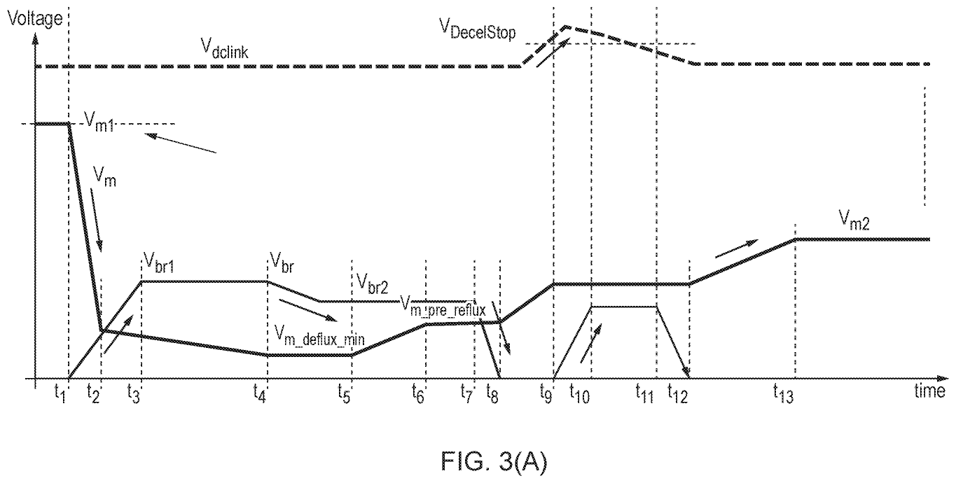

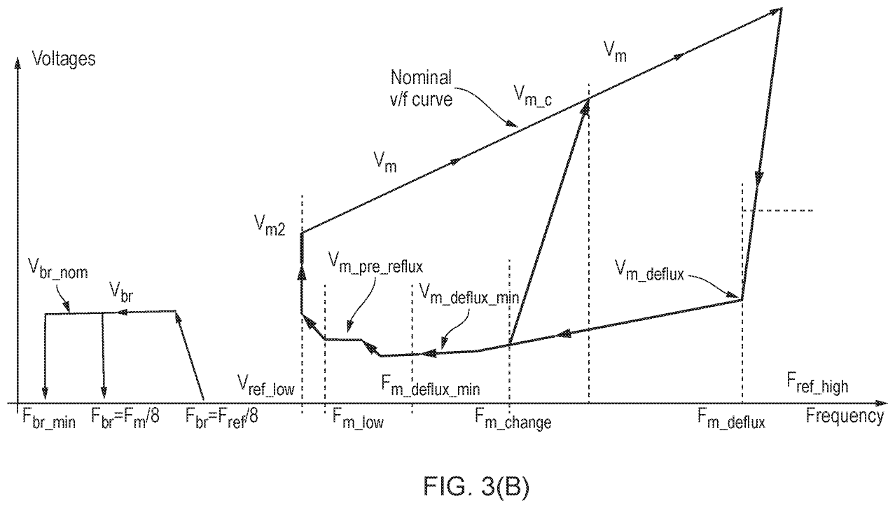

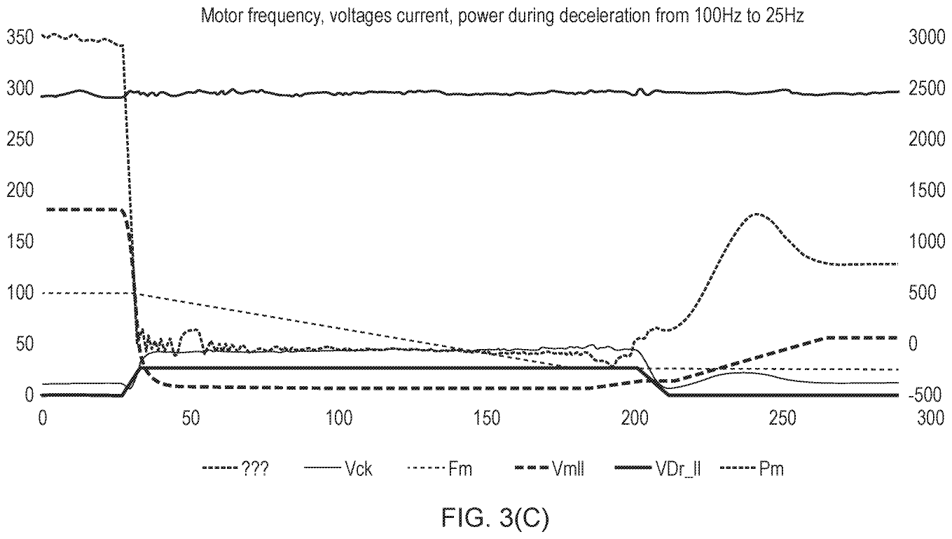

FIGS. 3A and 3B illustrate an example operation of the control circuitry 100 when slowing the induction motor 21, according to one embodiment. It will be appreciated that the control circuitry may be operated under the control of a computer program.

The AC dynamic braking process of embodiments is a variable frequency and voltage braking process which occurs four main stages: a de-flux stage, a braking stage, a de-braking stage and a motoring recovery stage. Operating conditions in some embodiments also have a possible over voltage suppress stage.

In FIGS. 3A and 3B, Vm is the motoring voltage; Vm1 is the nominal motoring voltage at the higher frequency Fref_high before deceleration; Vm2 is the nominal motoring voltage at the lower frequency Fref-low after deceleration; Vm_deflux_min is the minimum motoring voltage during deceleration; Vm_pre_reflux is the pre-reflux motoring voltage before the de-brake stage. Vb is the brake voltage; Vbr1 is the brake voltage at the higher rotating frequency during initial deceleration; Vbr2 is brake voltage at the lower rotating frequency near the end of deceleration; Vdclink is the dc link voltage.

Prior time t1, the induction motor 21 is being driven at a selected operating speed.

### De-Flux Stage

Stage 1: from t1 to t2—the motor de-flux stage. This stage time is overlapping with stage 2, the amplitude of the motoring voltage decreases from Vm1 to deflux the induction motor 21.

### Braking Stage

Stage 2: from t1 to t3—the amplitude of the brake voltage increases to Vbr1, control logic increases the current limit to a higher level.

Stage 3: from t3 to t4—motoring deceleration is stable, the braking voltage is steady and constant with an amplitude of Vbr1, the motoring voltage decreases with frequency to a pre-set de-fluxed amplitude of Vm_deflux_min.

Stage 4: from t4 to t5—the braking voltage is decreased to an amplitude of Vbr2, but the amplitude of the motoring voltage is kept at the pre-set the minimum amplitude of Vm_deflux_min in order maintain the minimum flux level to facilitate motoring recover after braking.

Stage 5: from t5 to t6—the amplitude of the motoring voltage is increased to Vm_pre_reflux to facilitate transit from braking to motoring modes.

Stage 6: from t6 to t7—waiting for rotor speed to fall and positive energy to be drawn by the induction motor 21.

### De-Braking Stage

Stage 7: from t7 to t8—if the target speed is approached within a pre-set range and the motor draws positive energy, then the amplitude of the braking voltage is decreased to zero before motoring recovery. Depending on parameter values, there might be a de-braking from Vbr1 to Vbr2 between t3 and t6 as shown.

### Motoring Recovery Stage

Stage 8: from t8 to t9—the amplitude of the motoring voltage increase from its Vdeflux_min voltage towards its nominal voltage Vm2 at the target speed after deceleration.

Stage 9: from t9 to t10—possible re-brake to suppress over voltage or over current trip if the dc link voltage rises unexpectedly higher than Vdecelstop, 115% of link idle voltage. If this happens, then the amplitude of the braking voltage is increased.

Stage 10: from t10 to t11—the amplitude of the braking voltage is maintained until the dc link voltage falls below Vdecelstop.

Stage 11: from t11 to t12—de-brake in over voltage suppress, end of re-braking. The amplitude of the braking voltage is decreased to zero.

Stage 12: from t12 to t13—continue motoring recovery to full flux; end of braking session. The amplitude of the motoring voltage is increased to Vm2.

FIG. 3B shows loci of voltage-frequency during dynamic braking, when the motor reference frequency is changed from Fref_high to Fref_low; the induction motor 21 reduces its frequency in steps and drops its voltage/frequency ratio at a pre-defined rate until they reach Fm_deflux and Vm_deflux.

A constant voltage/frequency ratio is maintained while the induction motor 21 continues to reduce its frequency until it reaches Fm_deflux_min while amplitude of the motoring voltage is kept at Vm_deflux_min. When the motor frequency reduces further to Fm_low, then the amplitude of the motor voltage is raised to Vm_pre_reflux and stays there until the brake voltage is removed when the amplitude of the motor voltage recovers to a nominal voltage Vm2 when motor frequency is around Fref_low.

The brake voltage frequency could be constant or varies at a fixed frequency ratio of Nbr, Nbr is 8, or 4 to the motoring frequency so that its frequency starts at Fref_high/Nbr and then moves down while its voltage increases (i.e. Nbr=fm/fbr=8 or 4). Its voltage is kept constant at Vbr and its lowest frequency is kept at Fbr_min. Before the motoring voltage recovered to nominal, Vbr is removed by dropping to zero either at Fbr_min or Fref_low/Nbr if it is larger than Fbr_min.

FIG. 3B illustrates the example where the link voltage is not charged higher than Vdecelstop and presents a simplified case than that shown in FIG. 3A. The loci in FIG. 3B would be more complicated if the link voltage is over charged in motoring recovery stage as shown in FIG. 3A.

If the reference speed suddenly changed back to Fref_high when the motor frequency is at Fmot_change before the motor decelerates to its initial target speed Fref_low, then the drive immediately accelerates by increasing motor flux, by increasing the motor voltage/frequency ratio to the nominal value, while the frequency increases in pre-defined steps towards to Fref_high.

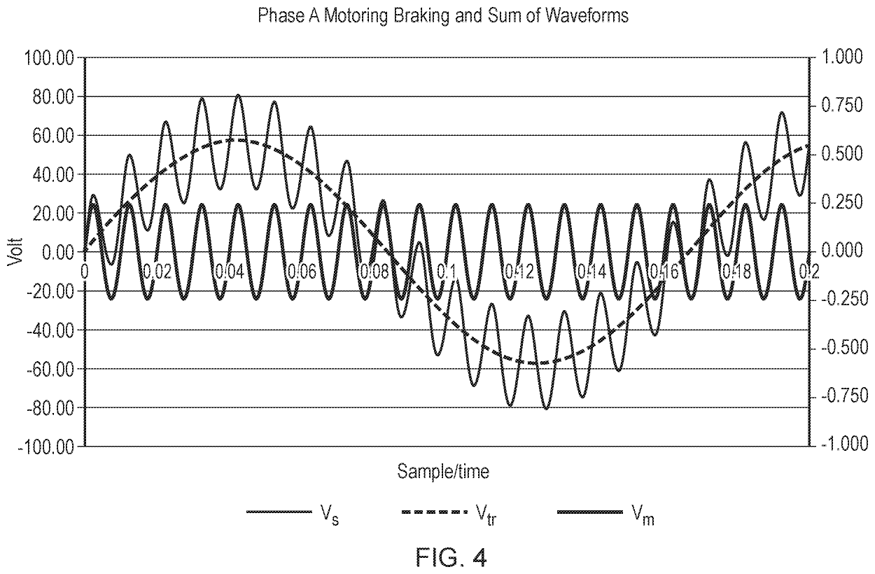

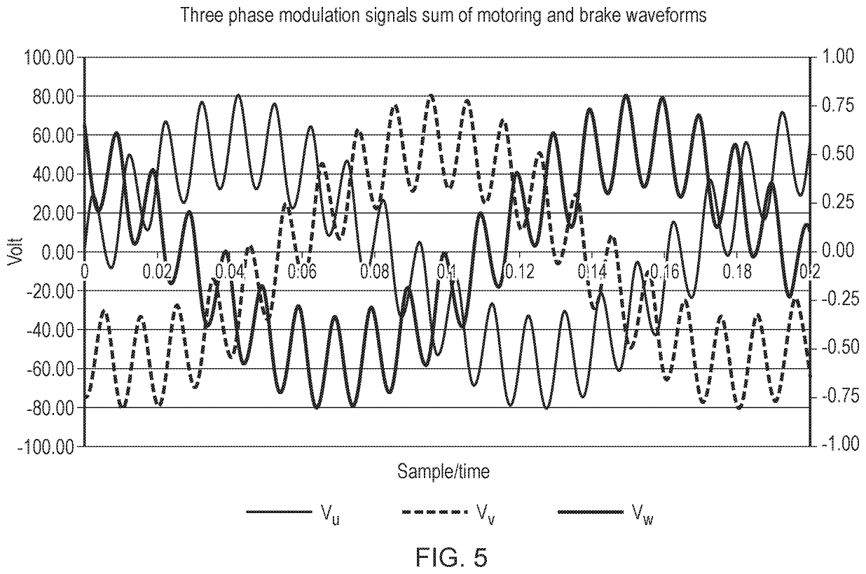

In other words, during deceleration or stop processes, the speed operation control 17 reduces the normal motoring voltage to weaken the flux level in the motor 21 and enables the brake function 16 to generate the lower frequency brake voltage Vbra and Vbrb so that the actual output voltages to motor 21 are Vsa=Vma+Vbra and Vsb=Vmb+Vbrb, (as shown in FIG. 4, which shows the phase A motoring, braking and sum of both voltages—in the steady state of braking shown in FIG. 4, the motoring voltage is smaller than the brake voltage). After the 2-to-3 phase conversion 14, the actual three phase fundamental voltages fed to the pulse width modulator 13 are shown in FIG. 5.

FIG. 3C is a data log of motoring, braking voltages and frequency during a decelerating test to illustrate the example where the link voltage is not charged higher than Vdecelstop. As can be seen, during a test on a cold pump whose no-load power is about 3 kW. Deceleration is smooth, there is no over voltage in link voltage. Irms is the stator current, Vdc is the dc link voltage, Fm is the motor frequency, Vm_ll is the motor line to line voltage, Vbr_ll is the brake line to line voltage and Pm is the motor power estimated by the drive.

Accordingly, it can be seen that embodiments reduce speed by dissipating kinetic energy inside the motor without needing an external energy dumping device and avoiding a drive over voltage. Embodiments provide much quicker state changes from motoring to braking and then recovery to continue motoring at lower speed periodically.

Embodiments suppress dc link over voltage even if the stator frequency is not changed, but the rotor is rotating faster than the stator frequency. This happens when rotor is forced to spin faster by a gas pressure difference “windmill effect” in, for example, a vacuum pump, it also happens at end of faster acceleration when the stator frequency reaches its target value and is stable, but the rotor speed still increases due to a large load inertia.

Hence, in embodiments, the braking voltage is adjusted to suppress dc link over voltage. In embodiments, the frequency change rate of the de-flux drive voltage component is adjusted to tracking rotor speed. In embodiments, the frequency change rate of the de-flux drive voltage component is adjusted to control the deceleration time period to avoid drive dc link over voltage.

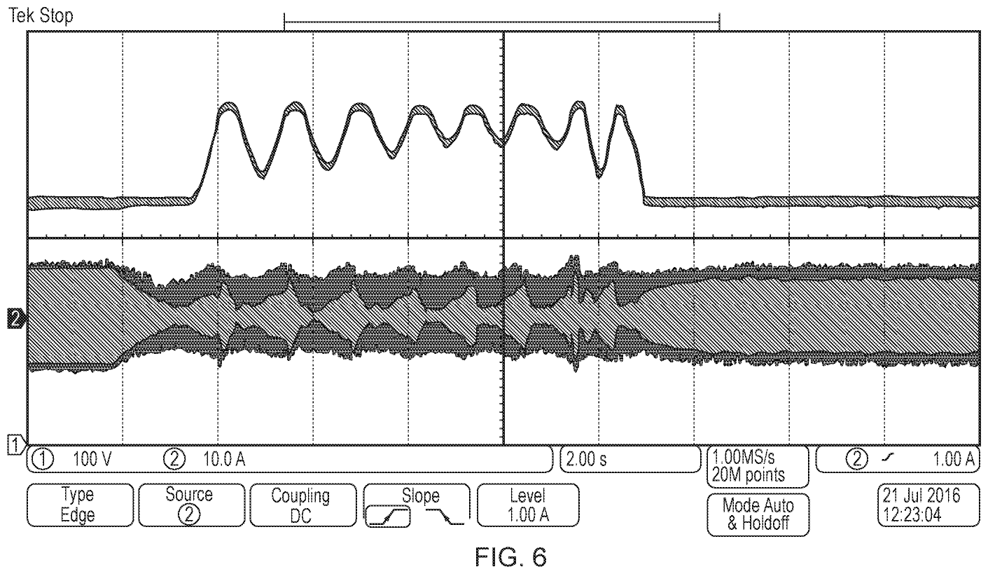

FIG. 6 shows deceleration current and DC link voltage waveforms in existing control circuitry without applying techniques of embodiments. As can be seen, it takes about 13 seconds to decelerate from 100 Hz to 50 Hz, charges the DC link voltage to 820V, 220V higher than normal operation voltage and risks an over-voltage trip. It takes an even longer time if the maximum DC link voltage is set to a lower value. Based on a production recommended parameter set, one pump is 3.5 Hz per second and others are 1.2 Hz per second. Using those parameters, one pump will take 14.3 seconds and others will take 42 seconds to reduce speed from 100 Hz to 50 Hz.

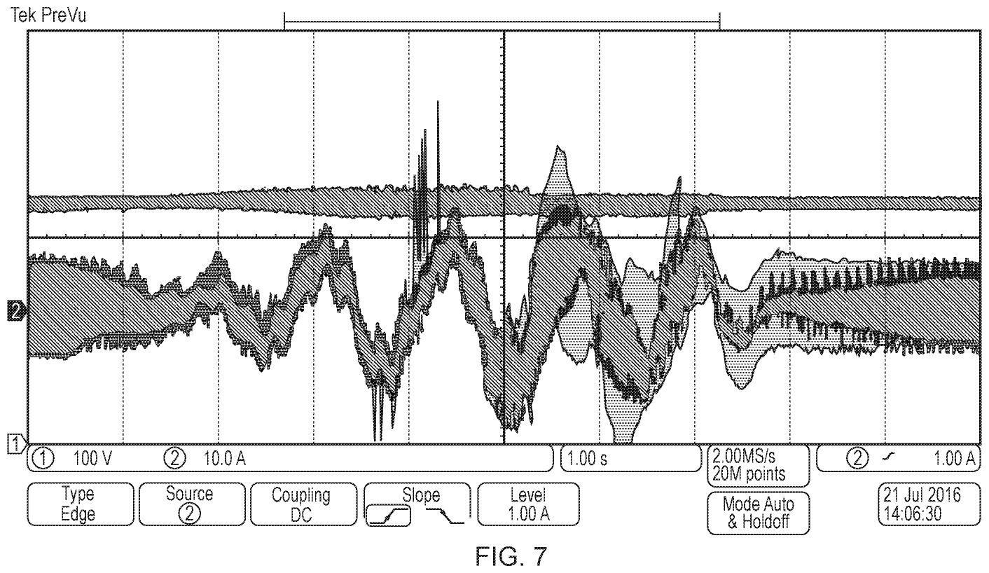

FIG. 7 shows the deceleration for the same pumps but using the AC braking of embodiments. In one pump, it takes 7 seconds to decelerate from 100 Hz to 50 Hz, a 46% reduction in time, its DC link voltage is not charged up higher than normal operation voltage, apart from some small ripple, and there is no risk of over-voltage trip.

Some benefits of embodiments are that it enables dynamic braking without the removal of the motoring voltage, it does not need an external device either to switch off the normal motoring voltage during braking, it does not need an external energy dump device that save space and cost, it controls and tracks the rotor speed during the braking operation so that changing from motoring to braking and back to motoring is smooth, it is applicable to either v/f or FOC control.

It will be appreciated that the brake frequency and voltage typically need to be selected so that the motor stator and rotor are not overheated by a cyclic deceleration-acceleration operation and the inverter power electronic devices are not overheated by its low frequency currents, as the thermal impedance of insulated-gate bipolar transistors are much higher at lower fundamental frequencies, their thermal capacity is degraded than at higher frequencies.

Accordingly, embodiments provide for AC dynamic braking of induction motors that combines the merits of regeneration with reduced deceleration time, while preventing the risk of an over-voltage fault which may result from driving large-inertia loads, such as a large roots vacuum pump or in other applications where a long, slow decelerating operation at ultimate pressure risks an over-voltage trip.

Some induction motors, such as those used in large roots-type boost pumps or in other applications, have a large inertia and are slow to change operation speed. For example, it takes 45 second to change from a current speed of 100 Hz to a target speed of 50 Hz in existing 6000 m³/hour mechanical boost pumps, faster deceleration will risk causing the drive DC link to experience an over voltage fault trip, resulting in it taking even longer time to reach the target speed. This performance makes it difficult meet requirements to decelerate more quickly such as in shorter period load lock pump cycles or in other circumstances.

Existing DC link dynamic braking requires some large-size energy dump device that can be hard to fit in some circumstances and increases cost. Embodiments instead dump kinetic energy into the motor internally, which enables the motor to brake more quickly. Unlike braking that only applies a single-phase or DC voltage when the normal motoring voltage has been removed and the rotor is coasting, embodiments apply a low-frequency braking voltage that creates a large negative slip and torque to slow down the rotor while the motoring voltage is still applied at a flux-weakened level; this helps track the rotor speed and enable a rapid recovery to normal motoring mode when target speed has been reached. Embodiments provide for simple control without any additional external devices requiring a circuit topology change for energy dumping. The brake current, torque and power are adjusted by varying the frequency and magnitude of the braking voltage to reduce unwanted vibration and noise during hard braking.

Unlike existing approaches, embodiments typically do not remove the normal motoring voltage, but instead reduce it (typically to lower than half of its pre-braking level) to a reduced motoring voltage to weaken magnetic flux during braking. This reduction still does not typically prevent the motor running into regeneration mode and over charging the DC link because the slip between the normal motoring voltage component and the rotor is a small, negative amount, typically about −3%. To help prevent regenerated energy over-charging the DC link capacitor bank, a lower-frequency braking voltage component, having a negative slip of about −300% to about −3000% and typically having a larger magnitude to the reduced motoring voltage component, is applied in superposition with to the reduced motoring voltage component. This large negative-slip braking will redirect regenerated energy, dissipating inside the motor and braking the rotor more quickly, forcing the motor into a dynamic brake mode.

When the motoring frequency approaches the lower target speed setting, the braking voltage component is reduced and removed and the motor resumes motoring mode smoothly. Should the magnitude of the motoring voltage have been reduced, then this is restored to its normal magnitude. Also, the slip between the motoring voltage and the rotor is a restored to a small, positive amount, typically about 3%.

Hence, it can be seen that embodiments provide AC dynamic braking that combines merits of regeneration and AC dynamic braking that reduces deceleration time and prevents an over-voltage fault in driving large inertia loads such as large roots vacuum pumps where long slow decelerating operation at ultimate pressure risks over-voltage trips.

Unlike other dynamic braking that applies single phase voltage or DC voltage when the motoring voltage is removed and the rotor is coasting, embodiments apply a low frequency three phase voltage that creates large negative slip and torque to slow down the rotor while the motoring voltage is still applied at reduced flux level, i.e. with flux weakening. This helps the control to track rotor speed and provides rapid recovery to the normal motoring mode when the target speed has been reached. This approach offers simple control without any external device and/or circuit topology change and/or energy dump. The braking current, torque and power can be adjusted by variation of the braking frequency and voltage to minimise unwanted heating, vibration and noise associated with hard braking.

Embodiments provide a braking method for power electronic inverter drive induction motor that applies a mix of normal motoring and braking components to generate combined regeneration and dynamic braking to reduce deceleration time and avoid feedback kinetic energy back to DC link and over charge the voltage of the capacitor bank. In embodiments, the normal motoring voltage component should be reduced to weak flux in motor and give up some capacity to the braking voltage component; its average slip is negative, but is not smaller than −10%; it resumes to normal motoring full flux operation after braking component is removed. In embodiments, the braking component frequency is much lower than the normal motoring component and final target speed, its average negative slip is smaller than −1, its voltage magnitude is not larger than the normal motoring component; it is in the same phase sequence as the motoring component. It ramps up and down to smooth brake torque and avoid unwanted mechanical impact to load. In embodiments, the normal motoring voltage component and braking voltage components are mixed by sum up in stationary reference frame algebraically. In embodiments, the normal motoring voltage and braking components could be generated and mixed up either in 2 phases or in three phase reference frames.

Although embodiments describe deceleration and then reassuming the motoring control, embodiments could also brake to stop, where the normal motoring voltage should be set to much smaller than braking voltage and deceleration rate should be larger for faster stopping.

In embodiments, three phase AC dynamic braking is performed, but it can also provide DC injection braking by changing its frequency and angle.

As alluded to above, there are various existing braking techniques. In many cases the requirement is to brake motor rotor to stop occasionally, and in the solutions, the rotor speed tracking is lost so it is not possible to return to motoring mode smoothly again without a lengthy re-starting process. Some methods may track speed, but these are only used in Field Oriented Control, used in advanced, high-performance drives, and are not compatible with more popular V/F ratio control. This embodiment delivers rapid deceleration and overvoltage prevention. Embodiments provide speed tracking and smooth change from motoring to braking and back to motoring mode.

Some existing braking techniques include: 1. DC link energy dumping, a chopper control braking torque by regulating external energy dump heat current; 2. DC injection braking, apply DC voltage in two phases of motor stator after motor is disconnected from drive; 3. Single phase AC braking method 1, apply a single phase power source to two phases, the third phase open, after motor is disconnected from drive; 4. Single phase AC braking method 2, apply a single phase power source to two phases, the third phase is parallel with one of the two phase if three phase in star connection; 5. Single phase AC braking method 3, apply a single phase power source to two terminals of open three phases connected in delta, this actually three phase are serial connection and powered by a single phase; 6. Capacitor braking, remove stator power supply and connect one or more capacitors on motor terminals that will self-excite like induction generator and brake rotor speed down: 7. High negative slip brake, apply a frequency to 55% of lower or negative slip about −80% to brake motor into stop; 8. Double Frequency Braking, apply a higher reverse sequence at fix frequencies difference, 9. Zero torque, magnet flux pulsation brake in FOC control. However, the main problems are they all lose track of rotor speed, only target to brake rotor to stop in 1-7, not suitable for fast deceleration purposes. 8 tracks speed, but only applicable to FOC control, where torque and magnet currents are separated accurately. 9 likes plugging brake, risks re-starting the rotor in the reverse direction which is not permitted in most types of pump mechanism.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A method of controlling an induction motor having a rotor and stator, comprising:
in response to an indication that a rotational frequency of said rotor is to be reduced from an initial operating frequency to a reduced operating frequency, applying an alternating braking voltage to said stator, said alternating braking voltage having a frequency selected to provide a slip of less than around −1.

2. The method of claim 1, wherein said alternating braking voltage has a frequency selected to provide a slip of less than around −3, and preferably between around −3 and −30.

3. The method of claim 1, wherein said alternating braking voltage has a frequency which is less than half of said reduced operating frequency.

4. The method of claim 1, comprising varying a frequency of said alternating braking voltage in proportion to said current operating frequency of said rotor.

5. The method of claim 1, comprising varying said frequency of said alternating braking voltage in proportion to said current operating frequency of said rotor to obtain a desired power dissipation inside said induction motor.

6. The method of claim 1, comprising varying said frequency of said alternating braking voltage in proportion to said current operating frequency of said rotor to obtain a desired slip to achieve said desired power dissipation inside said induction motor.

7. The method of claim 1, comprising varying said frequency of said alternating braking voltage to obtain a desired current generated by said induction motor.

8. The method of claim 7, comprising increasing said frequency of said alternating braking voltage when a current generated by said induction motor is greater than said desired current.

9. The method of claim 7, comprising decreasing said frequency of said alternating braking voltage when a current generated by said induction motor is less than said desired current.

10. The method of claim 1, wherein in response to said indication that said rotational frequency of said rotor is to be reduced from said initial operating frequency to said reduced operating frequency, the method comprises continuing to drive said induction motor with reduced flux in combination with applying said alternating braking voltage by reducing a magnitude of an alternating drive voltage.

11. The method of claim 10, wherein said magnitude of said alternating drive voltage is reduced by around more than half.

12. The method of claim 10, wherein a magnitude of said alternating braking voltage is higher than said magnitude of said alternating drive voltage.

13. The method of claim 1, comprising varying said magnitude of said alternating braking voltage based on a current operating frequency of said rotor.

14. The method of claim 1, comprising varying said magnitude of said alternating braking voltage to obtain a desired current generated by said induction motor.

15. The method of claim 14, comprising reducing said magnitude of said alternating braking voltage when a current generated by said induction motor is greater than said desired current.

16. The method of claim 14, comprising increasing said magnitude of said alternating braking voltage when a current generated by said induction motor is less than said desired current.

17. The method of claim 1, comprising ceasing to apply said alternative braking voltage when said rotational frequency of said rotor achieves said reduced operating frequency.

18. The method of claim 17, comprising increasing said magnitude of said alternating drive voltage.

19. An apparatus comprising:
control logic operable, in response to an indication that a rotational frequency of a rotor of an induction motor is to be reduced from an initial operating frequency to a reduced operating frequency, to apply an alternating braking voltage to said stator, said alternating braking voltage having a frequency selected to provide a slip of less than around −1.

20. (canceled)
